(19) United States
(12) Patent Application Publication
(10) Pub. No.: US 2022/0274251 A1
(43) Pub. Date: Sep. 1, 2022

(54) APPARATUS AND METHODS FOR INDUSTRIAL ROBOT CODE RECOMMENDATION

(71) Applicant: INTEL CORPORATION, Santa Clara, CA (US)

(72) Inventors: Javier Felip Leon, Hillsboro, OR (US); Ignacio Javier Alvarez, Portland, OR (US); David Isreal Gonzalez-Aguirre, Portland, OR (US); Javier Sabastian Turek, Beaverton, OR (US); Justin Gottschlich, Santa Clara, CA (US)

(21) Appl. No.: 17/525,785

(22) Filed: Nov. 12, 2021

(51) Int. Cl. B25J 9/16; G05B 13/02; G06N 3/04

(52) U.S. Cl. CPC B25J 9/163; G05B 13/027; G06N 3/0454; G06N 3/0445

(57) ABSTRACT

Methods, apparatus, systems, and articles of manufacture are disclosed for industrial robot code recommendation. Disclosed examples include an apparatus comprising: at least one memory; instructions in the apparatus; and processor circuitry to execute the instructions to at least: generate at least one action proposal for an industrial robot; rank the at least one action proposal based on encoded scene information; generate parameters for the at least one action proposal based on the encoded scene information, task data, and environment data; and generate an action sequence based on the at least one action proposal.

### FIELD OF THE DISCLOSURE

This disclosure relates generally to industrial robot programming and, more particularly, to apparatus and methods for industrial robot code recommendation.

### BACKGROUND

In recent years, manufacturers have increasingly relied on industrial robotic solutions. Industrial robots can perform repetitive, dangerous, and fatiguing tasks, efficiently produce consistent results. Industrial robots provide many advantages over traditional manufacturing methods, but must be programmed to perform desired tasks.

### BRIEF DESCRIPTION OF THE DRAWINGS

FIG. 1 is an illustration of an industrial environment including an industrial robot and code recommendation circuitry.

FIG. 2 is a block diagram of an example implementation of the code recommendation circuitry of FIG. 1.

FIG. 3 is a block diagram of an example implementation of the natural language encoder circuitry of FIG. 2.

FIG. 4 is a block diagram of example implementations of the action recommendation circuitry and parameter recommending circuitry of FIG. 2.

FIG. 5 is a flowchart representative of example machine readable instructions that may be executed by example processor circuitry to implement industrial robot code recommendations.

FIG. 6 is a flowchart representative of example machine readable instructions that may be executed by example processor circuitry to train artificial intelligence circuitry.

FIG. 7 is a flowchart representative of example machine readable instructions that may be executed by example processor circuitry to generate an action recommendation.

FIG. 8 is a flowchart representative of example machine readable instructions that may be executed by example processor circuitry to generate a parameter recommendation.

FIG. 9 is a flowchart representative of example machine readable instructions that may be executed by example processor circuitry to encode task data.

FIG. 10 is a flowchart representative of example machine readable instructions that may be executed by example processor circuitry to encode environment data.

FIG. 11 is a block diagram of an example processing platform including processor circuitry structured to execute the example machine readable instructions of FIGS. 5-10 to implement the code recommendation circuitry of FIGS. 1-4.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform to distribute software (e.g., software corresponding to the example machine readable instructions of FIGS. 5-10).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time ±1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Industrial robots increase efficiency in industrial environments by performing repetitive, dangerous, and fatiguing tasks. Common tasks for industrial robots include payload handling, cutting, spraying, and sealing. For example, industrial robots can handle heavy payloads and reduce physical demands on workers. Industrial robots can also handle dangerous tasks like cutting, freeing workers from potentially dangerous cutting elements such as lasers and water jets. Some industrial robots may spray volatile solvents, reducing worker exposure to the volatile solvents. Industrial robots can apply sealant and glue with control and consistency. In other systems, industrial robots can also weld, trim, polish, etc.

Industrial robots provide many advantages over traditional manufacturing methods. When compared to traditional methods, industrial robots can increase productivity, reduce product damage, increase manufacturing precision, and improve system flexibility. Such advantages have led to intense interest in industrial robotics in aerospace, healthcare, electronics, pharmaceutical, warehousing, and other industries.

Although industrial robots offer advantages to industries, introducing robots to an industrial environment can be costly and challenging. One major difficulty is that industrial robots require coded instructions to function. Coded instructions provide step-by-step instructions to industrial robots and provide an interface between workers and the robotic machines. Generating code for industrial robots is currently a time consuming, difficult, and often inefficient process. For example, code may be developed by a specialized industrial robot programmer at great expense. Yet, the same code may need to be adjusted many times for small differences in the industrial environment.

Some current industrial robot programming approaches define sequences of actions and commands, called action sequences. Action sequences may require intensive user parametrization. Such approaches can, for example, be based on icon-composition analogies via drag-and-drop placement and routing. While drag-and-drop robot programming is often more efficient than traditional, low-level robotic programming, drag-and-drop programming still involves specialized domain training. Moreover, the need to manually specify trivial actions in great detail is time consuming and often leads to errors.

Robot actions are behaviors, routines, and/or processes that produce a specific outcome. Robot actions can be combined in sequence to generate an action sequence. In some examples, action sequences are further refined by adjusting action parameters. Action parameters include variable components of an action and/or action sequence. In general, action sequences are actions with associated parameters that may be executed to complete a desired task.

Tasks may be associated with an environment (e.g., a warehouse). Tasks may additionally be associated with a scene that places specific constraints on components associated with the environment. For example, an environment may include a warehouse, the warehouse including a loading pallet and a conveyor belt. A scene associated with the warehouse environment may include an industrial robot in a specific cell of the environment, transporting objects a, b, and c to locations x, y, and z.

Prior industrial robot programming interfaces provide different approaches to generating action sequences. Prior solutions may include supervisory control and data acquisition diagrams, block-based diagrams, etc. However, prior solutions do not offer robust autocompletion capabilities to improve action sequence and parameter generation.

Prior Industrial robot programming interfaces and languages require expert knowledge and tedious manual input that yields low productivity. Prior industrial robot programming solutions lack robust perception systems to suggest new actions at programming time. Moreover, prior systems do not base suggested actions on natural language descriptions of an environment. Prior general approaches for word suggestion or code completion are not designed to leverage environmental, scene, and task data from the industrial environment.

Example industrial robotics code recommendation systems are disclosed herein. An example system includes action recommendation circuitry and parameter recommendation circuitry that leverages programmer intent for robot action sequence programming. The example system generates action sequences and provides action sequences to a robot to solve a task. In some examples, a contextualized-code autocomplete engine generates action sequence suggestions. In some examples, a contextualized-code autocomplete engine is trained on an existing code base of correct and/or successful programs validated by industrial workers.

The example systems described herein increases robotics programmer productivity and reduces reliance on domain knowledge for robotics programming. Tasks that are currently impractical to automate (e.g., high-mix, low-volume, made-to-order, etc.) benefit from the example system described herein. Additional benefits include increasing the number of tasks that can be delegated to robot systems.

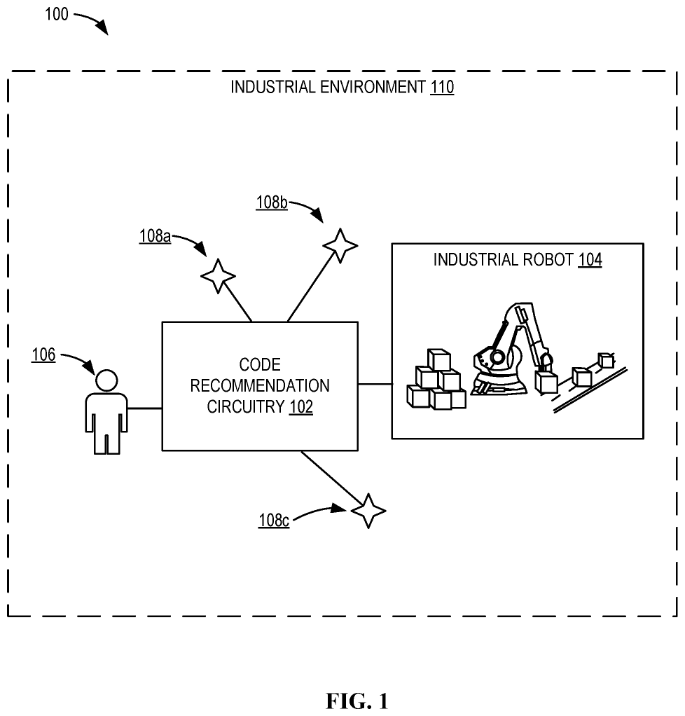

FIG. 1 is an illustration of an industrial environment including an industrial robot and code recommending circuitry. FIG. 1 includes an example industrial robotics code recommendation system 100, example code recommendation circuitry 102, an example industrial robot 104, an example user 106, an example first sensor 108a, an example second sensor 108b, an example third sensor 108c, and an example industrial environment 110.

The example industrial robotics code recommendation system 100 gathers information from at least three sources: (1) programmer intent through high level task description and contextual information, (2) sensor data, and (3) an annotated codebase of known programs. The example system 100 extracts programmer intent from a natural language description of a task to be executed. The example system 100 extracts contextual information based in part on a natural language description of an environment. Additionally, sensors (e.g., the example sensors 108a-108c) provide data to the example system 100. The example system 100 extracts and/or generates scene information based on the data. The codebase of known programs is augmented with natural language annotations that describe the tasks and the environments targeted by those programs.

The example code recommendation circuitry 102 generates an action sequence program from a task description, environmental data, scene data, and an augmented codebase. The example code recommendation circuitry 102 generates action recommendations for the action sequence based on natural language descriptions of tasks and the environment. The example code recommendation circuitry 102 additionally interfaces with a perception system (e.g., the example sensors 108a-108c) to encode a state of a scene to rank the action recommendations based on encoded scene data.

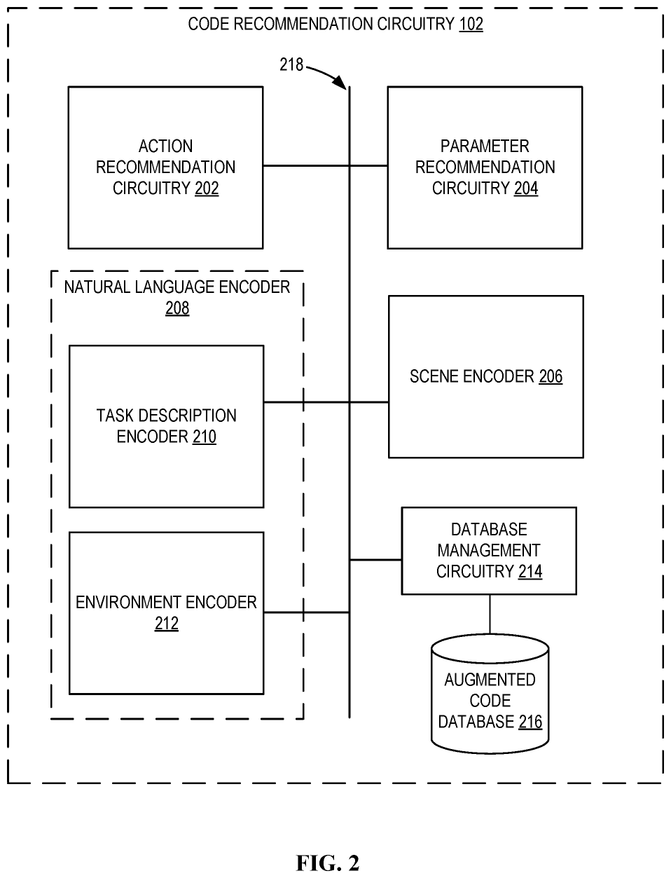

The example code recommendation circuitry 102 additionally generates parameter recommendations based on task, environment, and scene data. Further detail regarding the code recommendation circuitry 102 will be described below in association with FIGS. 2-10.

The example industrial robotics code recommendation system 100 is associated with the example industrial environment 110. The example industrial environment 110 is an industrial manufacturing warehouse that includes the example user 106, the example sensors 108a-108c, the example industrial robot 104, and the example code recommendation circuitry 102. The example industrial environment 110 is a manufacturing warehouse, with a worker who interacts with code recommendation circuitry 102 to control the industrial robot 104.

The example code recommendation circuitry 102 receives input from the example first sensor 108a, the example second sensor 108b, and the example third sensor 108c. The example sensors 108a-108c are image sensors which are used to capture photographs and/or images of the industrial environment 110. In some examples, the example sensors 108a-108c may instead be any other type of sensor and/or combination of sensors such as a proprioceptive sensor, a visible light imaging sensor, an infrared sensor, an ultrasonic sensor, temperature sensors, audio sensors, pressure sensors, force sensors, accelerometers, proximity sensors, ultrasonic sensors, etc. In some examples, the sensors 108a-108c may be referred to and/or be included in a larger perception system. In some examples, the sensors 108a-108c may capture data from the industrial environment 110.

The example industrial robot 104 is a robot used for manufacturing. The example industrial robot 104 is programmable and can execute action sequences provided by the example code recommendation circuitry 102. The example industrial robot 104 can manipulate an object with six degrees of freedom (6 DoF). However, in some examples, the code recommendation circuitry may interface with any other type of robot (e.g., a robot with fewer degrees of freedom). In some examples, the code recommendation circuitry 102 can generate action recommendations for more than one industrial robot. In such an example, additional management circuitry may be associated with the code recommendation circuitry 102.

The example industrial environment 110 includes the user 106, the sensors 108a-108c, the industrial robot 104, and the code recommendation circuitry 102. However, in some examples, a manufacturing environment may not include all of the user 106, the sensors 108a-108c, the industrial robot 104, and/or the code recommendation circuitry 102. For example, the code recommendation circuitry 102 may be housed in an external server or in a cloud computing environment. In some examples, the user 106 may not be a factory worker and may instead be an external safety operator, a programmer, a factory manager, etc., and located externally to the industrial environment 110.

FIG. 2 is a block diagram of an example implementation of the code recommendation circuitry 102 of FIG. 1. The code recommendation circuitry 102 includes example action recommendation circuitry 202, example parameter recommendation circuitry 204, an example scene encoder 206, an example natural language encoder 208, an example task description encoder 210, an example environment encoder 212, example database management circuitry 214, an example augmented code database 216, and an example communication bus 218.

The action recommendation circuitry 202 includes a generative artificial intelligence (AI) model that proposes actions based on representations of the task, environment, and scene. The example action recommendation circuitry 202 is trained, in part, on augmented code stored in the augmented code database 216. At training time, scene perception is generally not available, and therefore the generative AI model does not consider current scene state and objects to inform its proposals. However, the action recommendation circuitry 202 can still predict outputs accurately by using a current scene representation as a ranking system at runtime. Such a ranking system increases accuracy by reducing plausible actions.

The ranking system may be based on preconditions. An example action may have a precondition that is to be completed before performing the example action. For example, a grasp action may be associated with an object that is present and available in an example scene. By analyzing the example scene, actions that do not meet preconditions can have an associated priority reduced. Additionally, or alternatively, actions that do not have associated preconditions met may be discarded altogether. Additionally, or alternatively, a precondition can be met, but an example proposed action may have an associated priority reduced when scene data makes a proposed action unlikely to happen (e.g., manipulation is difficult due to other objects occluding the grasp). In some examples, proposal rankings are output in descending priority.

In some examples, the generative model architecture is capable of generating multiple outputs for a single input. The multiple outputs can be ranked by proposal ranking circuitry to recommend a subset of the multiple outputs.

The action recommendation circuitry 202 generates multiple outputs by showing topmost ranked actions after a ranking operation at a last layer of the generative model. In the example of FIG. 2, the ranking operation is a SoftMax operation. Additionally or alternatively, approaches such as dropout, ensemble methods, etc., can be used to rank predictions. In some examples, generative adversarial networks (GANs) or Bayesian neural networks generate samples from a learned probability distribution. GANs and Bayesian neural networks may produce improved results at the cost of increased computational overhead.

At runtime, the action recommendation circuitry 202 performs action recommendations based on an encoded task and environment description, an initial action sequence (that can be empty) and a scene state representation from sensor data. In some examples, proposals are accepted or rejected by a user (e.g., the user 106 of FIG. 1). The output of the action recommendation cirucitry 202 is a sequence of actions. The output is transmitted to the parameter recommendation circuitry 204. Additionally, or alternatively, the action sequence output may be passed to an action sequence memory which includes an initial action sequence and the output for input to subsequent predictions of the generative model.

The parameter recommendation circuitry 204 generates parameters of suggested actions. The parameter recommendation circuitry 204 uses scene perception as part of the training phase. At runtime, the scene perception (e.g., scene representation) is used as input to a second generative model. The second generative model may be based on similar artificial intelligence (AI) circuitry as the generative model of the action recommendation circuitry 202.

The example parameter recommendation circuitry 204 generates heterogeneous numbers of parameters across different actions and/or action sequences. Additionally, in some examples, a single parameter may have a different meaning depending on action, task, and/or scene data. However, in the example of FIG. 2, the number of possible action types is relatively low (e.g., in the dozens). Therefore, the parameter recommendation circuitry 204 includes action-wise models specialized in predicting action parameters for a specific action. For example, there may be three actions (e.g., move, push, pull). In such an example, the parameter recommendation circuitry 204 may include a generative model for each specific action (e.g., three distinct generative models). Then, based on the task, environment, scene, and previous action type, the parameter recommending circuitry can use a specific generative model.

Therefore, the parameter recommendation circuitry 204 trains a generative model for each action. Sensor input can be used to train each action specific generative model by running example tasks containing multiple actions. In such an example, the parameter recommendation circuitry 204 learns relationships between sensor input and action parameters.

In some examples, the output of the example parameter recommendation circuitry 204 is sent to a user (e.g., the user 106 of FIG. 1). Such output can then be fine-tuned by the user before performing additional parameter recommendations.

The example natural language encoder 208 of FIG. 2 includes the task description encoder 210 and the environment encoder 212. The task description encoder 210 takes in natural language input (e.g., from the example user 106 of FIG. 1) and extracts features that are fed into an acoustic model (e.g., a specialized acoustic model for the industrial robot). The output of the acoustic model is then and fed into a language model that outputs a text transcription of the natural language input (e.g., a spoken query). In some examples, the task description encoder 210 and the environment encoder 212 follow a similar encoding process.

In the example natural language encoder 208, the environment encoder 212 processes sequential data from the sensors 108a-108c, generating encoded environment data. The encoded environment data may be based on a spatio-temporal interest point or by applying two-dimensional convolutional neural network (CNN) feature extractors (e.g., AlexNet) in combination with three-dimensional CNN feature extractors (e.g., C3D). Output features from the 2D CNN and 3D CNN networks may be provided to a recurrent neural network (RNN) model such as a long short-term memory (LSTM) or a transformer model that preserves the temporal aspects of action sequences in description processing. Example output can include a text description of the current environment. In some examples, the output is generated in a windowed manner at a rate described in frames per second.

Encoded task and environment data may be expressed as a vector or word embedding. An example encoding method includes semantic lifting of natural language queries, parsing the query within the context of the industrial robot 104 of FIG. 1. In the example of FIG. 2, a semantic association model (e.g., word2vec) is applied to define a vector embedding dimensionality. In some examples, a custom specification description language (SDL) or scenario markup language (SML) is applied to describe structured intent. Such languages may allow specification of entities, the entity's properties in the industrial environment 110 of FIG. 1, and/or possible actions.

The scene encoder 206 provides a representation of a scene for use by action recommendation circuitry and/or parameter recommendation circuitry. In such an example, multi-modal contact and contactless sensors can be used. Sensors (e.g., the sensors 108a-108c) may also be aligned and synchronized to provide a time and space coherent symbolic representation of a scene.

For example, the industrial robot 104 may be mounted in front of a conveyor belt that transports objects. In this scenario, the robot and the conveyor belt provide information about their state based on sensor data. Additionally, if geometry and/or other characteristics scene objects is known, it may be that only a type, position, and orientation of an object (e.g., an object moved by a conveyor belt) remain unknown. The sensors 108a-108c may then collect data (e.g., camera sensor collects data) and send the data to object recognition circuitry that is associated with the example scene encoder 206, the example task description encoder 210, and/or the example environment encoder 212. Object recognition circuitry may perform a 6 DoF pose recognition/registration. In this way, sensor data is augmented with a description of objects in the example scene. The description output may be in the form of an array (e.g., [object_id, position (x, y, z), orientation (x, y, z, w), linear velocity (v)]). Therefore, the code recommendation circuitry 102 can take sensor data and generate data to facilitate action and parameter recommendations.

The database management circuitry 214 controls the augmented code database 216, loading and storing data from the augmented code database 216. Additionally, the database management circuitry 214 can send and/or receive information from other elements connected to the communication bus 218.

The augmented code database 216 includes code augmented with human descriptions of a task and an environmental context that an action sequence program is written for. In some examples, data annotation is based on comments in programs. In some examples, pre-existing comments are repurposed for augmentation. As the code recommendation circuitry operates, output action sequences and/or programs can be verified by human operators. Such programs can then be incorporated into the augmented code database 216, providing additional data for training.

The example communication bus 218 connects the recommendation circuitry 202, the parameter recommendation circuitry 204, the scene encoder 206, the natural language encoder 208, the task description encoder 210, the environment encoder 212, the database management circuitry 214, and the augmented code database 216.

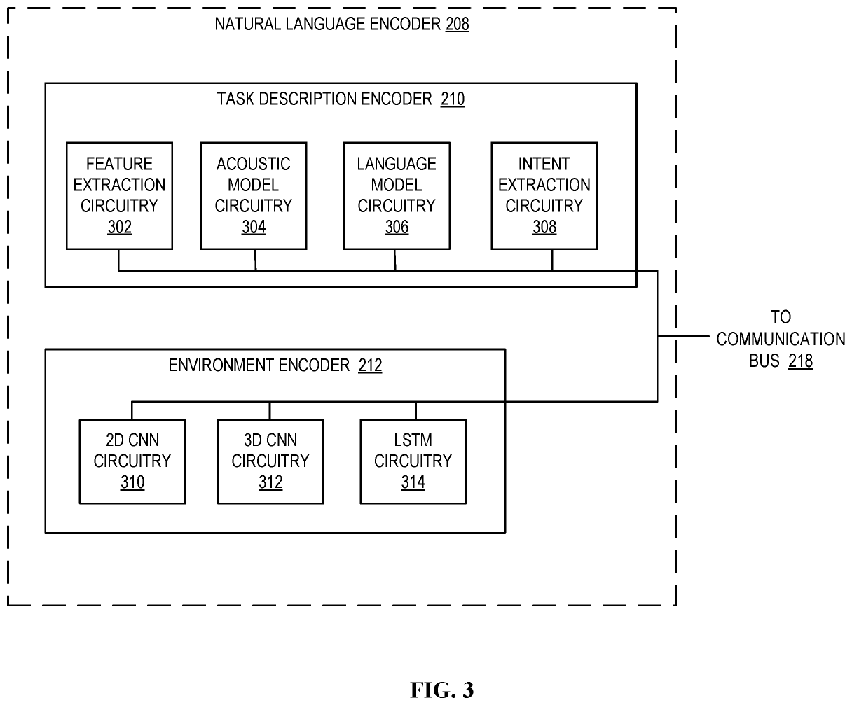

FIG. 3 is a block diagram of an example implementation of the natural language encoder 208 of FIG. 2. The natural language encoder 208 includes the task description encoder 210 and the environment encoder 212. The task description encoder 210 further includes example feature extracting circuitry 302, example acoustic model circuitry 304, example language model circuitry 306, and example intent extraction circuitry 308. The example circuitry 302-308 are connected to the communication bus 218. As described in association with FIG. 2, the task description encoder 210 takes in natural language input, providing the input to the feature extraction circuitry 302. Extracted features are transmitted to the acoustic model circuitry 304 to generate an acoustic model output. The acoustic model output is fed to the language model circuitry 306. Finally, any and/or all of these outputs are fed to intent extraction circuitry 308, which generates an encoded intent output and communicates the output via the communication bus 218.

The example environment encoder 212 includes example two-dimensional (2D) CNN circuitry 310, example three-dimensional (3D) CNN circuitry 312, and example LSTM circuitry 314. As described in association with FIG. 2, the environment encoder 212 processes sequential data from the sensors 108a-108c, generating encoded environment data. The example environment encoder 212 provides intermediate output from both the 2D CNN circuitry 310 and the 3D CNN circuitry 312 to the LSTM circuitry 314. The intermediate output may then be processed through a series of LSTM layers followed by any additional layers (e.g., a SoftMax layer) before being transmitted via the communication bus 218.

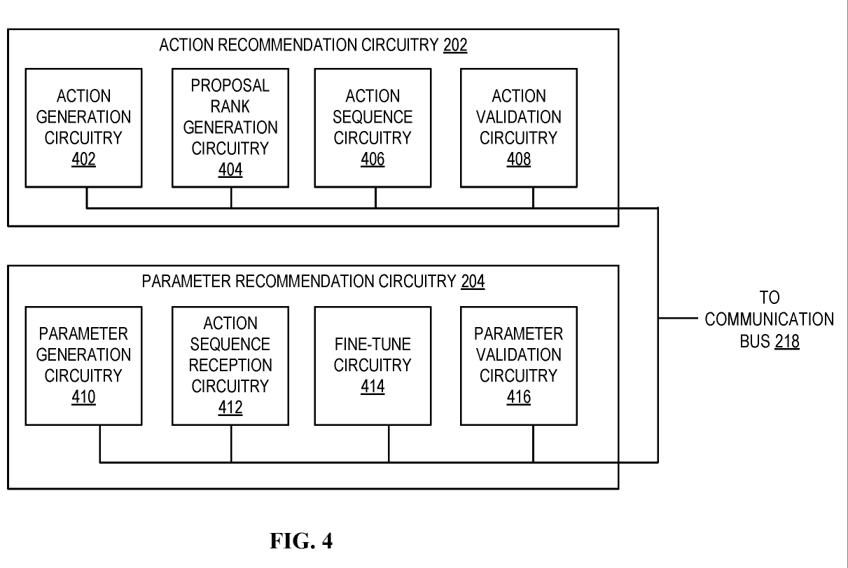

FIG. 4 is a block diagram of example implementations of the action recommendation circuitry 102 of FIG. 2 and the parameter recommendation circuitry 204 of FIG. 2. The action recommendation circuitry 202 includes example action generation circuitry 402, example proposal rank generation circuitry 404, example action sequence circuitry 406, and example action validation circuitry 408. The example action recommendation circuitry 202, described in association with FIG. 2, generates actions by at least one generative model. The generated actions (e.g., proposed actions) are then transmitted to proposal rank generation circuitry 404. The proposal rank generation circuitry 404 ranks and presents ranked results to the action validation circuitry 408. In some examples, the action validation circuitry 408 determines which action to send to the parameter recommendation circuitry 204. The parameter recommendation circuitry 204 may rank proposals based on encoded scene data. In some examples, the action validation circuitry 408 generates an indication to be transmitted to a user (e.g., the user 106 of FIG. 1). In such an example, the user may then accept or decline the recommendation.

The example action sequence circuitry 406 may include an action sequence memory. The action sequence memory may store previous actions and/or an initial action sequence to be provided to a generative model of the action generation circuitry 402. The example action generation circuitry 402, the example proposal rank generation circuitry 404, the example action sequence circuitry 406, and/or the example action validation circuitry 408 may each be connected by the communication bus 218.

The example parameter recommendation circuitry 204 includes example parameter generation circuitry 410, example action sequence reception circuitry 412, example fine-tune circuitry 414, and example parameter validation circuitry 416. The example parameter generation circuitry 410 includes at least one generative model which takes an action sequence, encoded environment data, encoded task data, and encoded scene data. In the example parameter recommendation circuitry 204, the action sequence is received by the action sequence reception circuitry 412. An action sequence may include both previous and suggested actions. Output of the parameter generation circuitry 410 may be passed to the parameter validation circuitry 416. The parameter validation circuitry 416 may allow a user (e.g., the user 106 of FIG. 1) to accept or reject at least one proposed parameter. Accepted parameters are transmitted to the fine-tune circuitry 414, which may automatically fine-tune parameters. In some examples, a user (e.g., the user 106 of FIG. 1) may fine-tune the parameters before the output is transmitted to the communication bus 218.

While an example manner of implementing the example code recommendation circuitry 102 of FIG. 1 is illustrated in FIGS. 2-4, one or more of the elements, processes, and/or devices illustrated in FIGS. 2-4 may be combined, divided, re-arranged, omitted, eliminated, and/or implemented in any other way. Further, the example action recommendation circuitry 202, the example parameter recommendation circuitry 204, the example scene encoder 206, the example natural language encoder 208, the example task description encoder 210, the example environment encoder 212, the example database management circuitry 214, the example augmented code database 216, the example communication bus 218, the example feature extraction circuitry 302, the example acoustic model circuitry 304, the example language model circuitry 306, the example intent extraction circuitry 308, the example 2D CNN circuitry 310, the example 3D CNN circuitry 312, the example LSTM circuitry 314, the example action generation circuitry 402, the example proposal rank generation circuitry 404, the example action sequence circuitry 406, the example action validation circuitry 408, the example parameter generation circuitry 410, the example action sequence reception circuitry 412, the example fine-tune circuitry 414, the example parameter validation circuitry 416, and/or more generally, the example code recommendation circuitry 102 of FIG. 1, may be implemented by hardware, software, firmware, and/or any combination of hardware, software, and/or firmware. Thus, for example, any of the example action recommendation circuitry 202, the example parameter recommendation circuitry 204, the example scene encoder 206, the example natural language encoder 208, the example task description encoder 210, the example environment encoder 212, the example database management circuitry 214, the example augmented code database 216, the example communication bus 218, the example feature extraction circuitry 302, the example acoustic model circuitry 304, the example language model circuitry 306, the example intent extraction circuitry 308, the example 2D CNN circuitry 310, the example 3D CNN circuitry 312, the example LSTM circuitry 314, the example action generation circuitry 402, the example proposal rank generation circuitry 404, the example action sequence circuitry 406, the example action validation circuitry 408, the example parameter generation circuitry 410, the example action sequence reception circuitry 412, the example fine-tune circuitry 414, the example parameter validation circuitry 416, and/or more generally, the example code recommendation circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example action recommendation circuitry 202, the example parameter recommendation circuitry 204, the example scene encoder 206, the example natural language encoder 208, the example task description encoder 210, the example environment encoder 212, the example database management circuitry 214, the example augmented code database 216, the example communication bus 218, the example feature extraction circuitry 302, the example acoustic model circuitry 304, the example language model circuitry 306, the example intent extraction circuitry 308, the example 2D CNN circuitry 310, the example 3D CNN circuitry 312, the example LSTM circuitry 314, the example action generation circuitry 402, the example proposal rank generation circuitry 404, the example action sequence circuitry 406, the example action validation circuitry 408, the example parameter generation circuitry 410, the example action sequence reception circuitry 412, the example fine-tune circuitry 414, and/or the example parameter validation circuitry 416 is/are hereby expressly defined to include a non-transitory computer readable storage device or storage disk such as a memory, a digital versatile disk (DVD), a compact disk (CD), a Blu-ray disk, etc., including the software and/or firmware. Further still, the example code recommendation circuitry 102 of FIG. 1 may include one or more elements, processes, and/or devices in addition to, or instead of, those illustrated in FIGS. 2-4, and/or may include more than one of any or all of the illustrated elements, processes and devices.

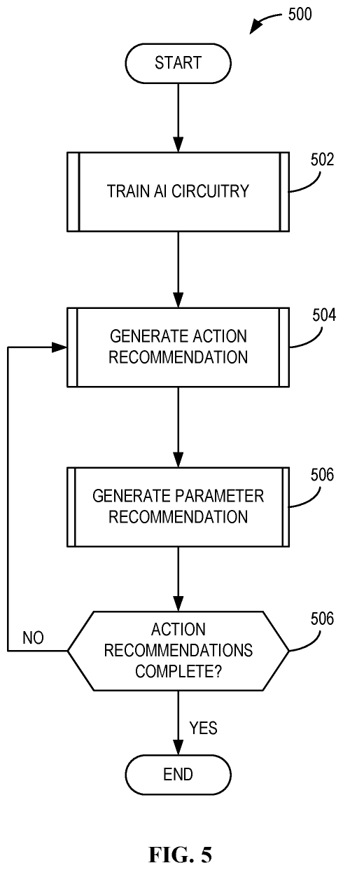

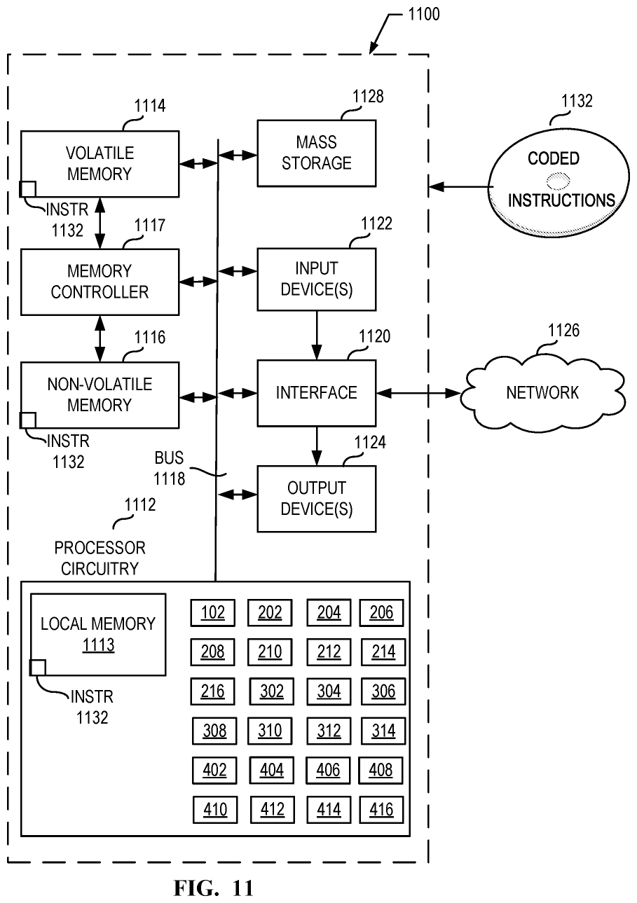

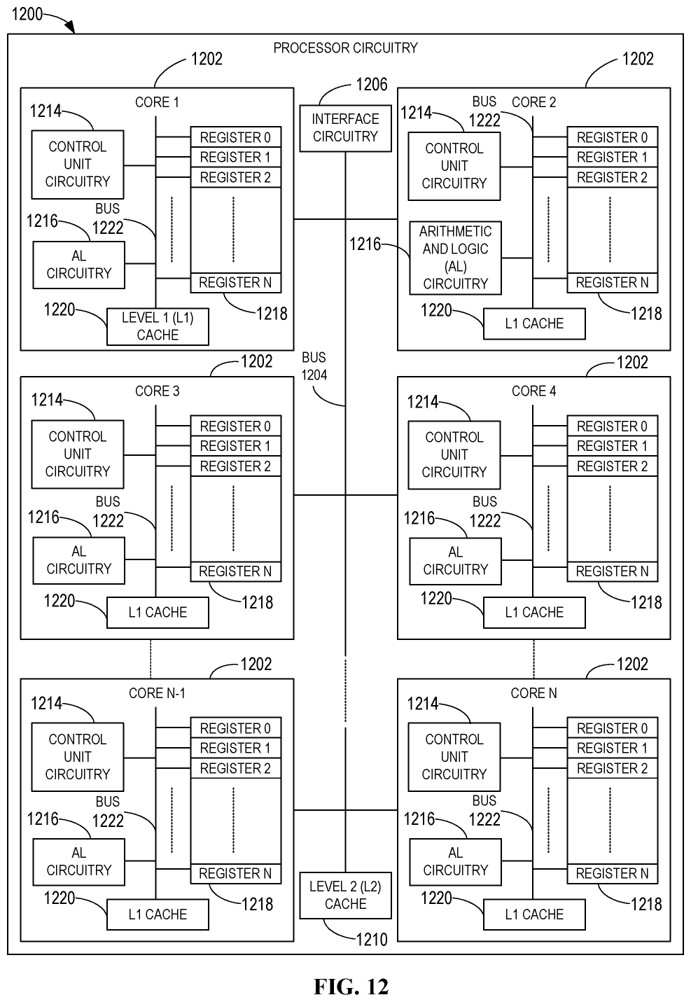

Flowcharts representative of example hardware logic circuitry, machine readable instructions, hardware implemented state machines, and/or any combination thereof for implementing the code recommendation circuitry 102 of FIG. 1 are shown in FIGS. 5-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 5-10, many other methods of implementing the example code recommendation circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

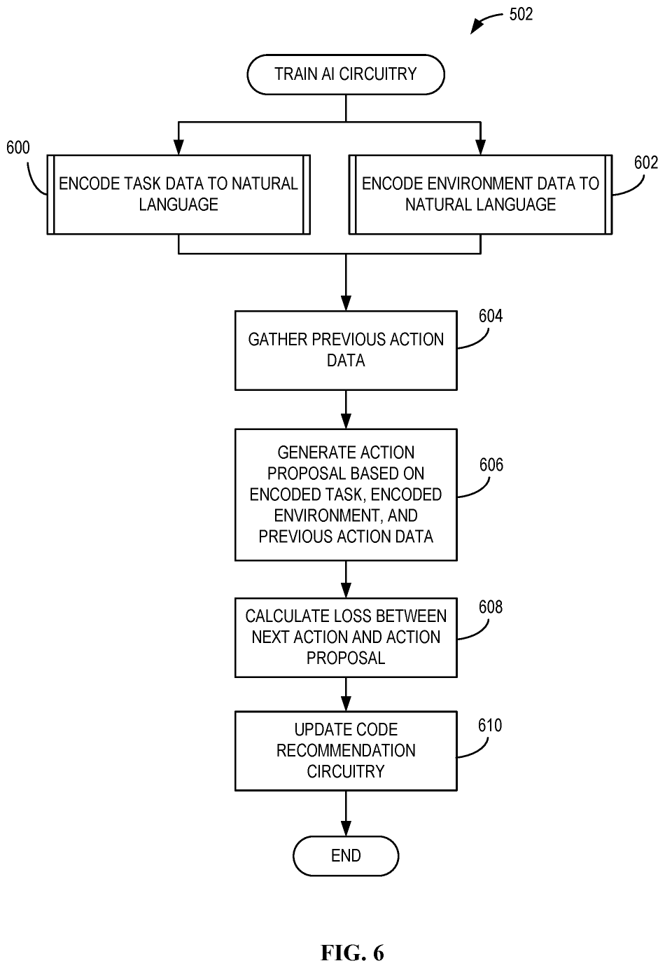

FIG. 5 is a flowchart representative of example machine readable instructions and/or example operations 500 that may be executed and/or instantiated by processor circuitry to implement industrial robot code recommendations. The machine readable instructions and/or operations 500 of FIG. 5 begin at block 502, at which the code recommendation circuitry 102 of FIGS. 1-4 is trained. The code recommendation circuitry 102 of FIGS. 1-4 includes at least two generative models which are additionally trained at block 502. The example action recommendation circuitry 202 of FIG. 2 is trained, in part, on augmented code stored in the augmented code database 216 of FIG. 2. At training time, scene perception is generally not available, so the generative AI model of the action recommendation circuitry 202 of FIG. 2 does not consider current scene information in training. the parameter recommendation circuitry 204 of FIG. 2 additionally trains second generative model(s) (e.g., one model per action). Sensor input can be used to train actions specific generative model by executing example tasks containing multiple actions. Additionally, the parameter recommendation circuitry 204 of FIG. 2 learns relationships between sensor input and action parameters at block 502. Further description of the operations of block 504 are described in relation to FIG. 6.

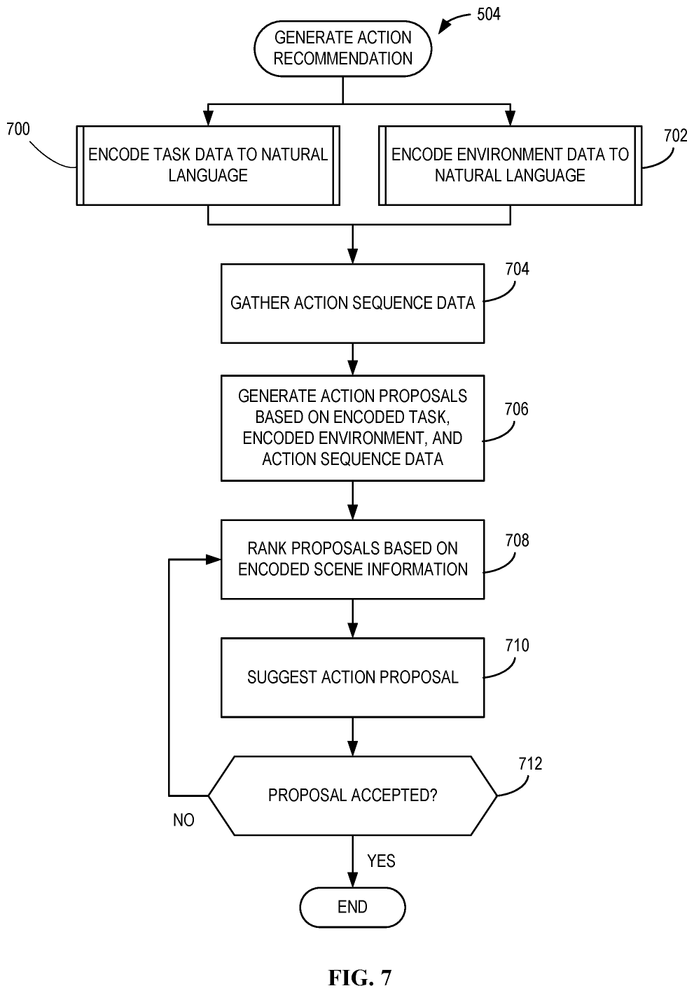

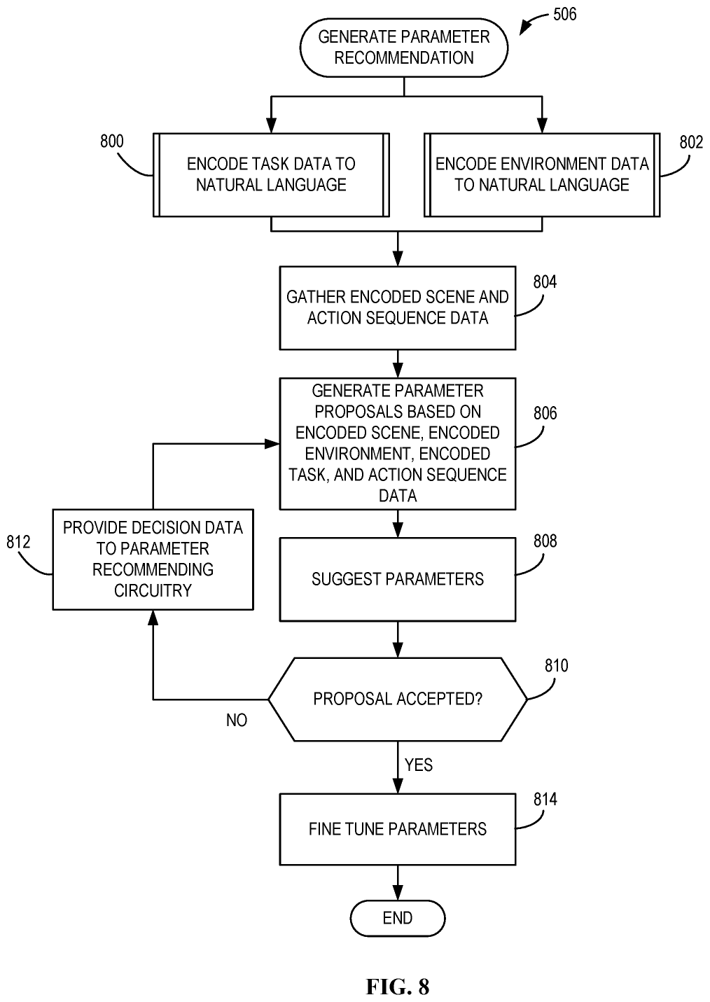

The machine readable instructions and/or operations 500 of FIG. 5 continue at block 504, at which the trained action recommendation circuitry 202 of FIG. 2 generates an action recommendation. Further description of the operations of block 504 are described in relation to FIG. 7. At block 506, the parameter recommendation circuitry 204, also trained, generates parameter recommendations. Further description of the operations of block 506 are described in relation to FIG. 8.

At block 506, the example database management circuitry 214 and/or the action recommendation circuitry 202 determines if action recommendations have been complete. In some examples, the determination may be based on an indication from a user (e.g., the user 106 of FIG. 1). If action recommendations are complete, the program ends. However, if more action recommendations are indicated, the program control goes to block 504 where additional action recommendations are generated.

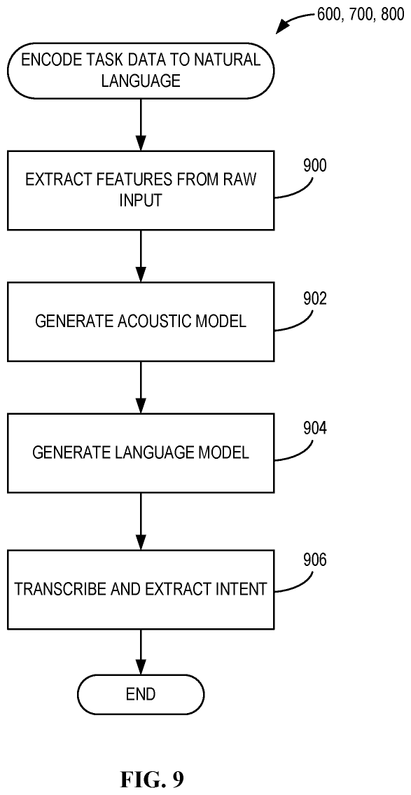

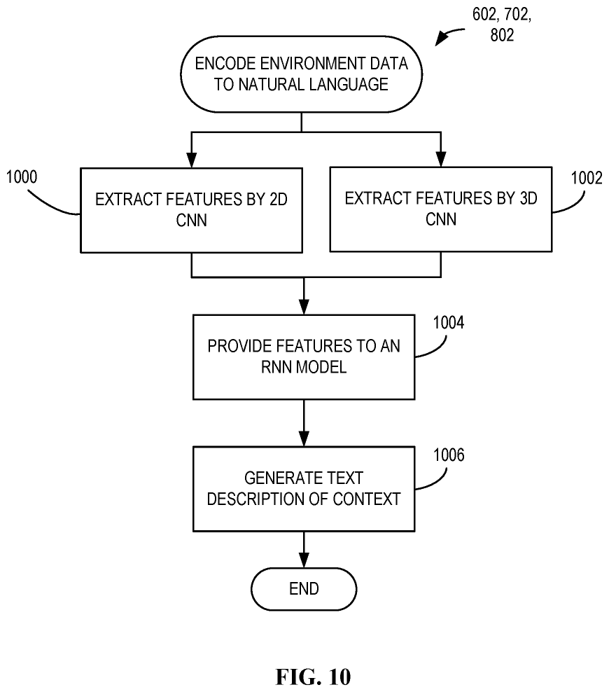

FIG. 6 is a flowchart representative of example machine readable instructions and/or example operations 502 that may be executed and/or instantiated by processor circuitry to train artificial intelligence circuitry. The machine readable instructions and/or operations 502 of FIG. 5 begin at blocks 600 and 602, at which the task description encoder 210 of FIG. 2 and the environment encoder 212 of FIG. 2 operate. At block 600, the task description encoder 210 encodes task data to natural language. Substantially in parallel, at block 602, the environment encoder 212 of FIG. 2 encodes environment data to natural language. The operations of blocks 600 and 602 will be described in further detail in relation to FIGS. 9 and 10, respectively.

At block 604, the action recommendation circuitry 202 of FIG. 2 and/or the parameter recommendation circuitry 204 of FIG. 2 gathers previous action data. Next, at block 606, the action recommendation circuitry 202 of FIG. 2 generates an action proposal based on encoded task, encoded environment, and previous action data. In some examples, the generative model architecture is capable of generating multiple outputs for a single input. The multiple outputs can be ranked by proposal ranking circuitry to recommend a subset of the multiple outputs. The action recommendation circuitry 202 of FIG. 2 may generate multiple outputs by showing topmost ranked actions after a ranking operation (e.g., SoftMax) at a last layer of the generative model. In some examples, generative adversarial networks (GANs) or Bayesian neural networks generate samples from a learned probability distribution.

At block 606, the action recommendation circuitry 202 of FIG. 2 and/or the parameter recommendation circuitry 204 of FIG. 2 generate action proposals based on encoded task, encoded environment, and previous action data. The action proposal at block 606 is to be compared to the expected next action. At block 608, the action recommendation circuitry 202 of FIG. 2 and/or the parameter recommendation circuitry 204 of FIG. 2 calculates a loss between an action proposal and the true next action. For example, if an action proposal is very different than the next action from the augmented code database 216 of FIG. 2, a loss value may be relatively high.

At block 610, the action recommendation circuitry 202 of FIG. 2 and/or the parameter recommendation circuitry 204 of FIG. 2 (of the code recommendation circuitry 102) adjust to generate future action recommendations more similar to the expected data from the augmented code database (e.g., the next operation). For example, the adjustment may be carried out by changing weights and biases of layers of a generative model of either the action recommendation circuitry 202 of FIG. 2 and/or the parameter recommendation circuitry 204 of FIG. 2. In some examples, an example adjustment is based on stochastic gradient descent and backpropagation.

FIG. 7 is a flowchart representative of example machine readable instructions and/or example operations 504 that may be executed and/or instantiated by processor circuitry to generate action recommendations. The machine readable instructions and/or operations 502 of FIG. 5 begin at blocks 700 and 702, at which the task description encoder 210 of FIG. 2 and the environment encoder 212 of FIG. 2 operate. At block 700, the task description encoder 210 of FIG. 2 encodes task data to natural language. Substantially in parallel, at block 702, the environment encoder 212 of FIG. 2 encodes environment data to natural language. The operations of blocks 700 and 702 will be described in further detail in relation to FIGS. 9 and 10, respectively.

At block 704, the example action recommendation circuitry 202 of FIG. 2 and/or the database management circuitry 214 of FIG. 2 gather action sequence data. Next, at block 706, the action recommendation circuitry 202 of FIG. 2 generates an action proposal based on encoded task, encoded environment, and cation sequence data. In some examples, the generative model architecture is capable of generating multiple outputs for a single input. In some examples, generative adversarial networks (GANs) or Bayesian neural networks generate samples from a learned probability distribution.

At block 708, the proposal rank generation circuitry 404 of FIG. 4 ranks proposals based on encoded scene information. A top ranked proposal is suggested by the proposal rank generation circuitry 404 of FIG. 4 at block 710. At block 712, the action validation circuitry 408 of FIG. 4 determines if the proposal suggested at block 710 is accepted. If so, the instructions 504 end. If the proposal at block 712 is not accepted, the suggested action proposal may be de-ranked and/or discarded before the action proposals are ranked again at block 708.

FIG. 8 is a flowchart representative of example machine readable instructions and/or example operations 504 that may be executed and/or instantiated by processor circuitry to generate parameter recommendations. The machine readable instructions and/or operations 506 of FIG. 5 begin at blocks 800 and 802, at which the task description encoder 210 of FIG. 2 and the environment encoder 212 of FIG. 2 operate. At block 800, the task description encoder 210 of FIG. 2 encodes task data to natural language. Substantially in parallel, at block 802, the environment encoder 212 of FIG. 2 encodes environment data to natural language. The operations of blocks 800 and 802 will be described in further detail in relation to FIGS. 9 and 10, respectively.

At block 804, the example parameter recommendation circuitry 204 of FIG. 2 and/or the database management circuitry 214 of FIG. 2 gather action sequence data. Next, at block 806, the parameter recommendation circuitry 204 of FIG. 2 generates parameter proposals based on encoded scene, encoded environment, encoded task, and action sequence data. The parameter recommendation circuitry 204 of FIG. 2 includes action-wise models specialized to predict action parameters for specific actions. In some examples, the parameter recommendation circuitry 204 of FIG. 2 may include a generative model for each specific action.

At block 808, the example parameter generation circuitry 410 of FIG. 4 suggests parameters. The suggestion may be based on an ordering of parameters. Top ranked proposal(s) is/are suggested by the parameter generation circuitry 404 of FIG. 4 at block 808. At block 810, the parameter validation circuitry 416 of FIG. 4 determines if the proposal suggested at block 808 is accepted. If not, the program continues to block 812, where the action sequence reception circuitry 412 of FIG. 4 and/or the parameter validation circuitry 416 of FIG. 4 provide decision data to the parameter generation circuitry 410 of FIG. 4 before additional proposals are generated at block 806.

If the proposal at block 810 is accepted, the accepted parameters are fine-tuned at block 814 by the fine-tune circuitry 414 of FIG. 4. In some examples, a user (e.g., the user 106 of FIG. 1) may fine-tune the parameters before the output. Fine-tuning may improve the accuracy and precision of the industrial code recommendation system 100 of FIG. 1 by allowing a user to perform alterations to the output of the suggested parameters.

FIG. 9 is a flowchart representative of example machine readable instructions and/or example operations 600, 700, and/or 800 that may be executed and/or instantiated by processor circuitry to encode task data to natural language. The machine readable instructions and/or operations 600, 700, and/or 800 of FIGS. 6-8 begin at block 900, at which the feature extraction circuitry 302 of FIG. 3 extracts features from raw input. At block 902, the acoustic model circuitry 304 of FIG. 3 generates an acoustic model. Then, at block 904, the language model circuitry 306 of FIG. 3 generates a language model before the intent extraction circuitry 308 of FIG. 3 extracts intent and transcribes the output at block 906.

FIG. 10 is a flowchart representative of example machine readable instructions and/or example operations 602, 702, and/or 802 that may be executed and/or instantiated by processor circuitry to encode task data to natural language. The machine readable instructions and/or operations 602, 702, and/or 802 of FIGS. 6-8 begin at block 1000 and 1002, at which the 2D CNN circuitry 310 of FIG. 3 and the 3D CNN circuitry 312 of FIG. 3 extract features substantially in parallel. At block 1004, a RNN model (e.g., LSTM circuitry 314 of FIG. 3) receives the extracted features. Finally, at block 1006, the environment encoder 212 of FIG. 2 generates a text description of the context.

FIG. 11 is a block diagram of an example processor platform 1100 structured to execute and/or instantiate the machine readable instructions and/or operations of FIGS. 5-10 to implement the code recommendation circuitry of FIGS. 1-5 The processor platform 1100 can be, for example, a server, a personal computer, a workstation, a self-learning machine (e.g., a neural network), a mobile device (e.g., a cell phone, a smart phone, a tablet such as an iPad^{™}), a personal digital assistant (PDA), a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example code recommendation circuitry 102, the example action recommendation circuitry 202, the example parameter recommendation circuitry 204, the example scene encoder 206, the example natural language encoder 208, the example task description encoder 210, the example environment encoder 212, the example database management circuitry 214, the example augmented code database 216, the example communication bus 218, the example feature extraction circuitry 302, the example acoustic model circuitry 304, the example language model circuitry 306, the example intent extraction circuitry 308, the example 2D CNN circuitry 310, the example 3D CNN circuitry 312, the example LSTM circuitry 314, the example action generation circuitry 402, the example proposal rank generation circuitry 404, the example action sequence circuitry 406, the example action validation circuitry 408, the example parameter generation circuitry 410, the example action sequence reception circuitry 412, the example fine-tune circuitry 414, and/or the example parameter validation circuitry 416

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output devices 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1132, which may be implemented by the machine readable instructions of FIGS. 5-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIGS. 5-10.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The bus 1220 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

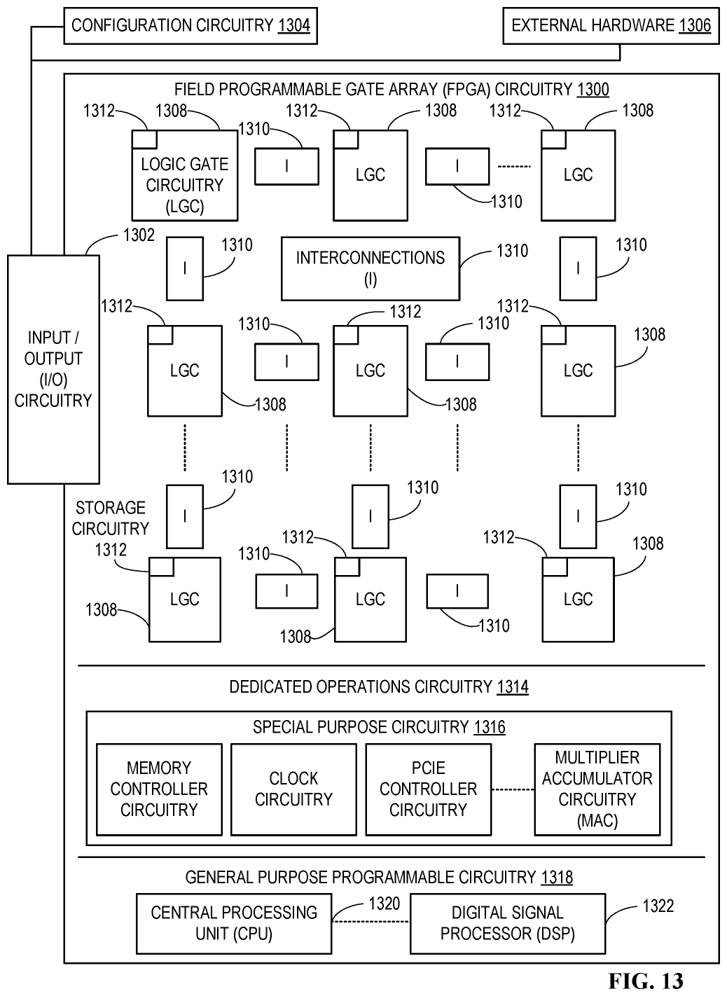

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowchart of FIGS. 5-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIGS. 5-10 In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowchart of FIGS. 5-10. As such, the FPGA circuitry 1300 may be structured to effectively instantiate some or all of the machine readable instructions of the flowchart of FIGS. 5-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIG. 13 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 5-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1220 of FIG. 12. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowchart of FIGS. 5-10 may be executed by one or more of the cores 1202 of FIG. 12 and a second portion of the machine readable instructions represented by the flowchart of FIGS. 5-10 may be executed by the FPGA circuitry 1300 of FIG. 13.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

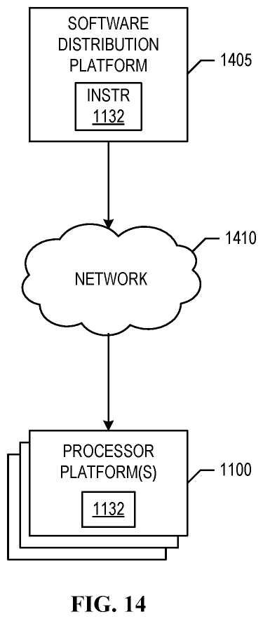

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11 . The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 5-10, as described above. The one or more servers of the example software distribution platform 1405 are in communication with a network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 11 of FIG. 11, may be downloaded to the example processor platform 400, which is to execute the machine readable instructions 1132 to implement the example industrial robotics code recommendation system 100. In some example, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that generate industrial robot code recommendations. The disclosed systems, methods, apparatus, and articles of manufacture improve the efficiency of using a computing device by allowing programmers to describe described by the programmer (e.g., store this item). The example systems described herein increases robotics programmer productivity and reduces reliance on domain knowledge for robotics programming. Tasks that are currently impractical to automate (e.g., high-mix, low-volume, made-to-order, etc.) benefit from the example system described herein. Additional benefits include increasing the number of tasks that can be delegated to robot systems. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to generate industrial robot code recommendations are disclosed herein. Further examples and combinations thereof include the following:

Example 1 includes an apparatus comprising at least one memory, instructions in the apparatus, and processor circuitry to execute the instructions to at least generate at least one action proposal for an industrial robot, rank the at least one action proposal based on encoded scene information, generate parameters for the at least one action proposal based on the encoded scene information, task data, and environment data, and generate an action sequence based on the at least one action proposal.

Example 2 includes the apparatus of any of the previous examples, wherein the processor circuitry is to execute the instructions to generate the at least one action proposal based on a first generative artificial intelligence model, and generate parameters for the at least one action proposal based on a second generative artificial intelligence model including the encoded scene information, the task data, and the environment data.

Example 3 includes the apparatus of any of the previous examples, wherein the processor circuitry is to execute the instructions to train the first and second generative artificial intelligence models based on encoded task, encoded environment, and previous action data.

Example 4 includes the apparatus of any of the previous examples, wherein the processor circuitry is to encode the task data by executing the instructions to extract features from a natural language input, generate an acoustic model, generate a language model, and extract intent from the features based on an output of the language model.

Example 5 includes the apparatus of any of the previous examples, wherein the processor circuitry is to encode the task data by executing the instructions to extract spatial features based on a two dimensional convolutional neural network (CNN), extract temporal features based on a three dimensional CNN, provide the spatial features and the temporal features to a recurrent neural network (RNN), and extract intent from the spatial and temporal features based on an output of the RNN.

Example 6 includes the apparatus of any of the previous examples, wherein the task data and the encoded scene information include code from an augmented code database.

Example 7 includes the apparatus of any of the previous examples, wherein the processor circuitry is to execute the instructions to capture the environment data by at least one of a proprioceptive sensor of the industrial robot, a visible light imaging sensor, an infrared sensor, an ultrasonic sensor, and a pressure sensor.

Example 8 includes a computer readable medium comprising instructions, which, when executed, cause processor circuitry to at least generate at least one action proposal for an industrial robot, rank the at least one action proposal based on encoded scene information, generate parameters for the at least one action proposal based on the encoded scene information, task data, and environment data, and generate an action sequence based on the at least one action proposal.

Example 9 includes the computer readable medium of any of the previous examples, wherein the instructions, when executed, cause the processor circuitry to generate the at least one action proposal based on a first generative artificial intelligence model, and generate parameters for the at least one action proposal based on a second generative artificial intelligence model including the encoded scene information, the task data, and the environment data.

Example 10 includes the computer readable medium of any of the previous examples, wherein the instructions, when executed, cause the processor circuitry to train the first and second generative artificial intelligence models based on encoded task, encoded environment, and previous action data.

Example 11 includes the computer readable medium of any of the previous examples, wherein the instructions, when executed, cause the processor circuitry to extract features from a natural language input, generate an acoustic model, generate a language model, and extract intent from the features based on an output of the language model.

Example 12 includes the computer readable medium of any of the previous examples, wherein the instructions, when executed, cause the processor circuitry to extract spatial features based on a two dimensional convolutional neural network (CNN), extract temporal features based on a three dimensional CNN, provide the spatial features and the temporal features to a recurrent neural network (RNN), and extract intent from the spatial and temporal features based on an output of the RNN.

Example 13 includes the computer readable medium of any of the previous examples, wherein the task data and the encoded scene information include code from an augmented code database.

Example 14 includes the computer readable medium of any of the previous examples, wherein the instructions, when executed, cause the processor circuitry to capture the environment data by at least one of a proprioceptive sensor of the industrial robot, a visible light imaging sensor, an infrared sensor, an ultrasonic sensor, and a pressure sensor.

In any of example 8 to example 14, the example computer readable medium may be a non-transitory computer readable medium.

Example 15 includes a method comprising generating, by executing an instruction with processor circuitry, at least one action proposal for an industrial robot, ranking, by executing an instruction with the processor circuitry, the at least one action proposal based on encoded scene information, generating, by executing an instruction with the processor circuitry, parameters for the at least one action proposal based on the encoded scene information, task data, and environment data, and generating, by executing an instruction with the processor circuitry, an action sequence based on the at least one action proposal.

Example 16 includes the method of any of the previous examples, further including generating the at least one action proposal based on a first generative artificial intelligence model, and generating parameters for the at least one action proposal based on a second generative artificial intelligence model including the encoded scene information, the task data, and the environment data.

Example 17 includes the method of any of the previous examples, further including training the first and second generative artificial intelligence models based on encoded task, encoded environment, and previous action data.

Example 18 includes the method of any of the previous examples, further including extracting features from a natural language input, generating an acoustic model, generating a language model, and extracting intent from the features based on an output of the language model.

Example 19 includes the method of any of the previous examples, further including extracting spatial features based on a two dimensional convolutional neural network (CNN), extracting temporal features based on a three dimensional CNN, providing the spatial features and the temporal features to a recurrent neural network (RNN), and extracting intent from the spatial and temporal features based on an output of the RNN.

Example 20 includes the method of any of the previous examples, wherein the task data and the encoded scene information include code from an augmented code database.

Example 21 includes the method of any of the previous examples, further including capturing the environment data by at least one of a proprioceptive sensor of the industrial robot, a visible light imaging sensor, an infrared sensor, an ultrasonic sensor, and a pressure sensor.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
at least one memory;
instructions in the apparatus; and
processor circuitry to execute the instructions to at least:
generate at least one action proposal for an industrial robot;
rank the at least one action proposal based on encoded scene information;
generate parameters for the at least one action proposal based on the encoded scene information, task data, and environment data; and
generate an action sequence based on the at least one action proposal.

2. The apparatus of claim 1, wherein the processor circuitry is to execute the instructions to:
generate the at least one action proposal based on a first generative artificial intelligence model; and
generate parameters for the at least one action proposal based on a second generative artificial intelligence model including the encoded scene information, the task data, and the environment data.

3. The apparatus of claim 2, wherein the processor circuitry is to execute the instructions to train the first and second generative artificial intelligence models based on encoded task, encoded environment, and previous action data.

4. The apparatus of claim 1, wherein the processor circuitry is to encode the task data by executing the instructions to:
extract features from a natural language input;
generate an acoustic model;
generate a language model; and
extract intent from the features based on an output of the language model.

5. The apparatus of claim 1, wherein the processor circuitry is to encode the task data by executing the instructions to:
extract spatial features based on a two dimensional convolutional neural network (CNN);
extract temporal features based on a three dimensional CNN;
provide the spatial features and the temporal features to a recurrent neural network (RNN); and
extract intent from the spatial and temporal features based on an output of the RNN.

6. The apparatus of claim 1, wherein the task data and the encoded scene information include code from an augmented code database.

7. The apparatus of claim 1, wherein the processor circuitry is to execute the instructions to capture the environment data by at least one of a proprioceptive sensor of the industrial robot, a visible light imaging sensor, an infrared sensor, an ultrasonic sensor, and a pressure sensor.

8. A non-transitory computer readable medium comprising instructions, which, when executed, cause processor circuitry to at least:
generate at least one action proposal for an industrial robot;
rank the at least one action proposal based on encoded scene information;
generate parameters for the at least one action proposal based on the encoded scene information, task data, and environment data; and
generate an action sequence based on the at least one action proposal.

9. The non-transitory computer readable medium of claim 8, wherein the instructions, when executed, cause the processor circuitry to:
generate the at least one action proposal based on a first generative artificial intelligence model; and
generate parameters for the at least one action proposal based on a second generative artificial intelligence model including the encoded scene information, the task data, and the environment data.

10. The non-transitory computer readable medium of claim 9, wherein the instructions, when executed, cause the processor circuitry to train the first and second generative artificial intelligence models based on encoded task, encoded environment, and previous action data.

11. The non-transitory computer readable medium of claim 8, wherein the instructions, when executed, cause the processor circuitry to:
extract features from a natural language input;
generate an acoustic model;
generate a language model; and
extract intent from the features based on an output of the language model.

12. The non-transitory computer readable medium of claim 8, wherein the instructions, when executed, cause the processor circuitry to:
extract spatial features based on a two dimensional convolutional neural network (CNN);
extract temporal features based on a three dimensional CNN;
provide the spatial features and the temporal features to a recurrent neural network (RNN); and
extract intent from the spatial and temporal features based on an output of the RNN.

13. The non-transitory computer readable medium of claim 8, wherein the task data and the encoded scene information include code from an augmented code database.

14. The non-transitory computer readable medium of claim 8, wherein the instructions, when executed, cause the processor circuitry to capture the environment data by at least one of a proprioceptive sensor of the industrial robot, a visible light imaging sensor, an infrared sensor, an ultrasonic sensor, and a pressure sensor.

15. A method comprising:
generating, by executing an instruction with processor circuitry, at least one action proposal for an industrial robot;
ranking, by executing an instruction with the processor circuitry, the at least one action proposal based on encoded scene information;
generating, by executing an instruction with the processor circuitry, parameters for the at least one action proposal based on the encoded scene information, task data, and environment data; and
generating, by executing an instruction with the processor circuitry, an action sequence based on the at least one action proposal.

16. The method of claim 15, further including:
generating the at least one action proposal based on a first generative artificial intelligence model; and
generating parameters for the at least one action proposal based on a second generative artificial intelligence model including the encoded scene information, the task data, and the environment data.

17. The method of claim 16, further including training the first and second generative artificial intelligence models based on encoded task, encoded environment, and previous action data.

18. The method of claim 15, further including:
extracting features from a natural language input;
generating an acoustic model;
generating a language model; and
extracting intent from the features based on an output of the language model.

19. The method of claim 15, further including:
extracting spatial features based on a two dimensional convolutional neural network (CNN);
extracting temporal features based on a three dimensional CNN;
providing the spatial features and the temporal features to a recurrent neural network (RNN); and
extracting intent from the spatial and temporal features based on an output of the RNN.

20. The method of claim 15, wherein the task data and the encoded scene information include code from an augmented code database.

21. The method of claim 15, further including capturing the environment data by at least one of a proprioceptive sensor of the industrial robot, a visible light imaging sensor, an infrared sensor, an ultrasonic sensor, and a pressure sensor.
